(19) United States
(12) Patent Application Publication
(10) Pub. No.: US 2013/0098944 A1
(43) Pub. Date: Apr. 25, 2013

(54) Container Assembly With Dual Means of Dispensing Fluids

(71) Applicant: Myrtle Broadney, Fayetteville, GA (US)

(72) Inventor: Myrtle Broadney, Fayetteville, GA (US)

(21) Appl. No.: 13/279,989

(22) Filed: Oct. 24, 2011

(51) Int. Cl. G01F 11/00; B67D 3/00

(52) U.S. Cl. 222/321.9; 222/481

(57) ABSTRACT

The inventive concept discloses a container assembly for dispensing consumer-useable fluids, comprising 1) a bottle-type container having a neck with an opening and an open bottom portion, 2) a finger-operated pump head apparatus attachable to the neck, 3) a dip tube, and 4) a removable cup-like structure attachable to the bottom portion of the container. The bottom structure of the bottle consists of an integral means for readily attaching or detaching the cup-like structure. Thus, the removable cup-like structure allows a consumer access to the last remnants of fluids such as lotions, shampoos, etc., that may be entrapped after the dip tube has lost its effectiveness at siphoning the fluid content upward toward the pump head.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE. TO A “SEQUENCE LISTING,” A TABLE, OR A COMPUTER PROGRAM LISTING APPENDIX

Not applicable.

### BACKGROUND OF THE INVENTION

(1) Field of the Invention

This inventive concept relates to bottles and containers that dispense viscous or semi-viscous fluids which are personally useable by consumers. Such products would include lotions, creams, shampoos, hair conditioners, analgesics, and the like. Further, this inventive concept relates to a new design for a pump-spray container assembly that dispenses such fluids.

For decades, bottles and containers with liquid or viscous fluid contents have been sold in high volume to both individual consumers and professional markets in the United States and in almost every foreign country. These bottles and containers are poured into pump or spray bottles prior to shipment to a point of delivery or retail outlet.

Containers of the type related to the inventive concept herein may be manufactured for the purpose of pumping, spraying, misting, foaming, or atomizing its contents. A conventional spray bottle package is constructed of two separate basic components, which would include a pump or spray head provided with a dip tube and a bottle having a threaded neck at its top. The conventional spray head is provided with an inner threaded coupler, which threadedly connects with an outer threaded neck portion of an appropriate bottle.

The conventional liquid pump bottle is provided with an exteriorly-threaded neck portion having an opening through which a specific volume of fluid or liquid is added during a filling procedure at a manufacturing facility. After the filling operation, the dip tube of the pump bottle is inserted through the opening in the neck, and then the inner threaded coupler of the conventional spray head is rotated, by means of a compatible right hand thread, to the exteriorly-threaded neck portion of the pump bottle. Thus, there is provided a secure connection and a virtual hermetic seal between the spray head and the neck portion of the liquid pump bottle. In modern manufacturing facilities, the process of filling, inserting the dip tube, and rotating and tightening the threaded coupler of the spray head to the threaded neck portion of the bottle is accomplished by high-speed machine automation.

The conventional spray or pump bottle packaging for consumer use is generally a non-reusable package which is normally discarded by the user after the contents are consumed. A sometimes irritating facet of the use of such spray or pump bottles is that, as the contents of the bottle diminish with regular dispensing, there is typically a quantity of fluid content remaining in the bottom of the bottle which cannot be siphoned up through the dip tube. An objective of the inventive concept presented herein is to provide a secondary dispensing bottom portion of the bottle, thereby allowing the consumer to access all of the remaining fluid in the pump spray bottle after the effectiveness of the dip tube is lost.

In the United States, generally pump head components are manufactured by a very limited number of large injection molding manufactures such as AFA, Calmar, Continental, and Owens-Brockway. Pump and/or spray bottles are manufactured by a wide variety of blow molding companies, including the fluid producers or distributors themselves. The manufacture of custom pump spray bottles, which include the secondary dispensing bottom as disclosed by the inventive concept herein, should not present a problem.

(2) Description of the Related Art

including information disclosed under 37 CFR 1.97 and 1.98.

The inventor in U.S. Pat. No. 5,829,607 (Nov. 3, 1998; Ibrahim) discloses a double-ended bottle having two narrow necks at opposed ends of the bottle. Sloped shoulders provide gentle transition between each neck and the full width of the body of the bottle. Each neck has a threaded cap having two features for sealing against leaks past the cap. The caps are of diameters equal to that of the body, so that the bottle may be stood upright on a horizontal surface on either cap.

In U.S. Pat. No. 6,138,870 (Oct. 31, 2000; Lin), A two-chamber milky lotion bottle is integrally molded from clear plastic material. A nozzle is associated with the outer cap with a nozzle head projected from the outer cap and a nozzle tube downward extended through the top opening of the inner cap and into the inner chamber. The outer chamber surrounds the inner chamber and has a downward opening. A bottom plate is connected to the downward opening of the outer chamber such that a dual-liquid ornament may be contained in the outer chamber.

The inventor in U.S. Pat. No. 6,319,453B1 (Nov. 20, 2001; Klima, Jr. et al.) presents a spray bottle having at least two neck portions located substantially within a center portion of the width of the spray bottle, the spray bottle including a first neck portion oriented substantially parallel relative to the longitudinal axis of the spray bottle, and including a second neck portion oriented perpendicularly or upwardly at an angle substantially in the range of 0° to 90° relative to a longitudinal axis of the spray bottle.

US#2007/0284332 A1 (Dec. 13, 2007; Gowans et al.) discloses a liquid container featuring multiple openings for accessing the contents. The container is shaped as a bottle, having body and neck, with a first opening at the top of the neck. A flat bottom or base opposite the neck features a traditional soda can opening with a scored section and a tab. In some embodiments, the entire bottom may function as a removable lid.

Patent application publication #CN 201027007(Y) discloses an invention by inventor, Lihua Xu, of China. The embodiment shown relates to a dual-opening bottle which comprises a shampoo bottle. The invention is characterized in that both ends of the shampoo bottle are respectively equipped with an opening and a cap. When only a small quantity of shampoo is left in the bottom of the bottle, opening the bottom cap can easily extrude the remaining quantity.

### BRIEF SUMMARY OF THE INVENTION

This inventive concept discloses a container assembly comprising 1) a hollow, primarily oblong container having (a) an exteriorly-threaded upper neck with an opening and (b) an open bottom, 2) a pump head apparatus having interior threads compatible with the threads of the upper neck, 3) a conventional pump-handle suitable for finger or hand-activated operation, 4) a dip tube, and 5) a removable cup-like structure attachable to the bottom of the container. Various embodiments of the inventive concept may be designed to function without either or both the pump head apparatus and the pump handle. The bottom structure of the oblong container comprises an integral means for readily attaching or detaching the cup-like structure.

The bottom of the container, along with the detachable cup-like structure, allows the consumer access to the last remnants of fluids that may be enclosed after the dip tube loses its effectiveness at siphoning the fluid content upward into the pump head. The container is generally oriented vertically when in use, in order to facilitate operation of the finger pump mechanism at the neck of the container. Typically, as the level of a fluid nears the bottom of the container, the user may turn the pump/spray bottle sideways, remove the cap, and incrementally over a period of time, pour out the remnants of the fluid. However, the inventive concept disclosed herein makes accessing the fluid much quicker and more efficient.

The hollow container itself may be of varying shape, including an essentially cylindrical shape, an elliptical shape, a bulb-like shape, or the shape of any geometrical figure. The bottom closing device may comprise a sealing cup, a stopper cup, or a ridged cup, any type of structure that will have a structure compatible with the hollow container. For illustrative purposes only, in this application, the preferred embodiments will be shown as either a cylindrical, elliptical, or bulb-like shape.

The bottom closing mechanism featured in this application may further comprise a variety of mechanisms, including threaded receptacles, ridged closures, grooved interlocking parts, and the like. The best mode of the inventive concept features, as a bottom closing mechanism, a threaded cup-like device. The cup-like device may be either (1) interiorly-threaded for closure by rotatable insertion onto an exteriorly-threaded bottom portion of the container, (2) exteriorly-threaded for closing by rotatable insertion into interior threads of the bottom portion of the container, or (3) comprising a ridged cup, constructed so as to fit snugly over an outer perimetral flange on the bottom portion of the container.

### BRIEF DESCRIPTION OF THE VIEWS OF THE DRAWINGS

FIG. 1 illustrates a full length view of a cylindrically-shaped container, showing the internal dip tube and the externally-threaded bottom of the container.

FIG. 1A presents a top view of the cylindrical container, including the liquid pump dispenser.

FIG. 2 shows a frontal view of an essentially elliptical container, along with the externally-threaded bottom portion of the container.

FIG. 2A presents a top view of the elliptical container, including the liquid pump dispenser, which is attached to the neck of the container.

FIG. 2B is a side view of the elliptical container shown in FIG. 2.

FIG. 3 represents a top view of the internal containment area of the sealing cup, further showing the cross-sectional line A-A.

FIG. 3A is a cross-sectional side view of the internally-threaded sealing cup as viewed from section line A-A.

FIG. 4 presents a full-length side view of a bulb-shaped container, showing the sealing cup secured to the bottom portion of the container.

FIG. 5 is a view looking downward into the recessed opening of the exteriorly-threaded cup-stopper.

FIG. 5A shows a side view of the exteriorly-threaded cup-stopper.

FIG. 6 presents a cross-sectional view of a cylindrically-shaped container, having only a cap and the interior threads, as viewed from section line B-B of FIG. 6A.

FIG. 6A illustrates a top view of the cylindrically-shaped container, having a cap attached to the neck.

FIG. 7 shows a full-length cutaway side view of a bulb-shaped container assembly, having an internally-threaded bottom portion, as viewed from section line C-C of FIG. 7A.

FIG. 7A presents a top view of the bulb-shaped container, further showing the pump handle and a cross-sectional line C-C which defines the view shown in FIG. 7.

FIG. 8 is a full-length front view of the elliptical-shaped container assembly, displaying a sealing cup as the bottom closing mechanism.

FIG. 8A presents a top view of the elliptical-shaped container assembly, further showing the pump handle.

FIG. 8B illustrates a side view of the elliptical-shaped container assembly.

FIG. 9 is a top view of the interior of the ridged-cup closing mechanism, also showing cross-sectional line D-D, which defines the view presented in FIG. 9A

FIG. 9A presents a cutaway side view of the ridged cup closing mechanism, as seen from the orientation of cross-sectional line D-D.

FIG. 9B presents a cross-sectional side view of a cylindrical container, depicting the location of the container flange, used for securing the ridged cup.

### DETAILED DESCRIPTION OF THE INVENTION

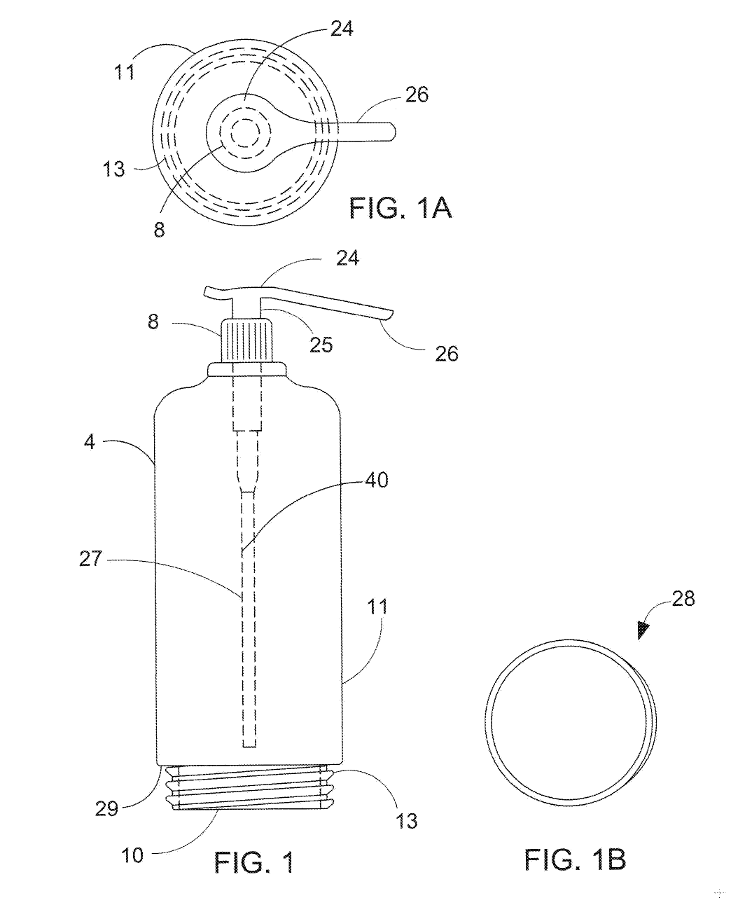

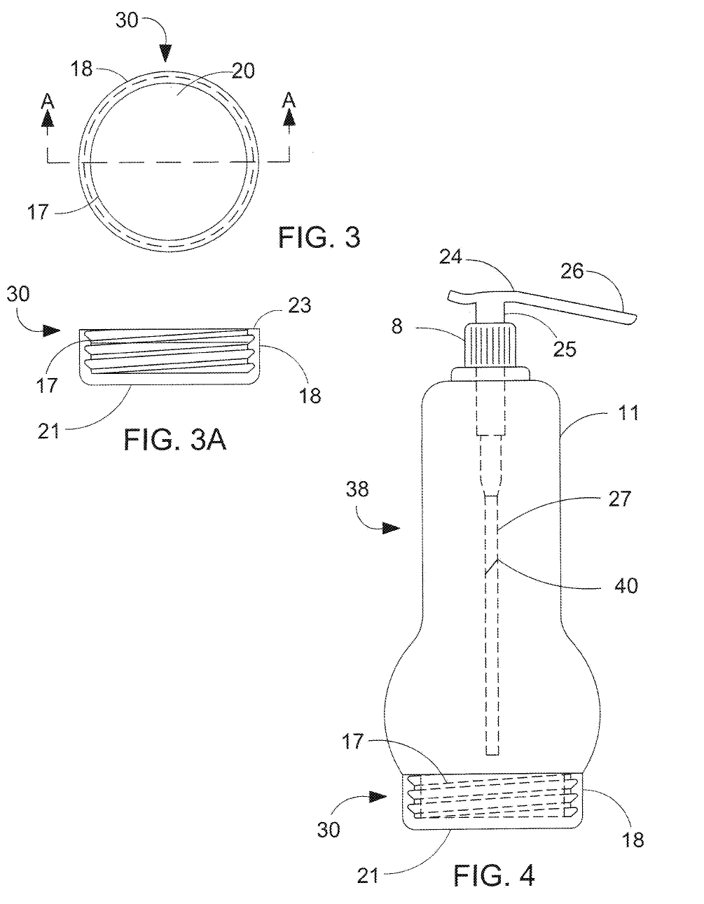

We may refer to FIG. 1 to gain a basic understanding of the inventive concept. In FIG. 1 there is shown the body of a cylindrical container 4 having outer bottom threads 13 at the bottom of the cylindrical container 4 and further, having a cap 8 securing a pump head (not shown) and a dip tube 27. A pump handle 24 directly operates the pump head which causes fluid in the cylindrical container to be emitted through a spout 26. The dip tube 27 may further be scored 40 to facilitate a consumer breaking off a substantial portion of the dip tube 27 to gain easier access to any fluid remnants within the cylindrical container 4 or within the dip tube 27, itself. To make a complete container assembly, the cylindrical container 4 must be securely fitted with a sealing cup 30, such as shown in FIGS. 3 and 3A.

In viewing FIGS. 3 and 3A, it is seen that the sealing cup 30 comprises a circular cup having an inner floor 20, a flat bottom 21 for resting the container on a substrate, and interior threads 17 which are compatible with the outer bottom threads 13 of the cylindrical container 4. At the time of manufacture, and prior to the time of filling of the cylindrical container 4 with a desired fluid, the sealing cup 30 is rotated, in a clockwise direction (as viewed from the bottom of the cylindrical container 4) onto the outer bottom threads 13 of the cylindrical container 4. As further assurance of preventing leakage of the fluid, a gasket 28, as shown in FIG. 1B, may be abutted against the flange 29 of the cylindrical container 4. The flange 29 is then fitted snugly against the rim 23 of the sealing cup 30 as the sealing cup 30 is rotated tightly onto the outer bottom threads 13 of the cylindrical container 4.

When the cylindrical container 4 containing the consumable fluid is delivered to the ultimate customer, a period of time will elapse during which, through regular usage, any fluid in the cylindrical container 4 will decrease to a level which is not siphonable by the dip tube 27. The remnants of fluid will collect predominantly on the floor 20 of the sealing cup 30. As this occurs, the consumer is able to remove the sealing cup 30 (FIG. 3A) by rotating the sealing cup 30 counter-clockwise (as seen from the bottom of the cylindrical container 4). The counter-clockwise rotation slidably releases the sealing cup's 30 inner threads 17 from their binding contact with the container's 4 outer bottom threads 13, allowing the complete removal of the sealing cup 30. For an indeterminate number of future removals of the sealing cup 30, the consumer is able to access the remnants of the product fluid in the container 4 on a gradual basis.

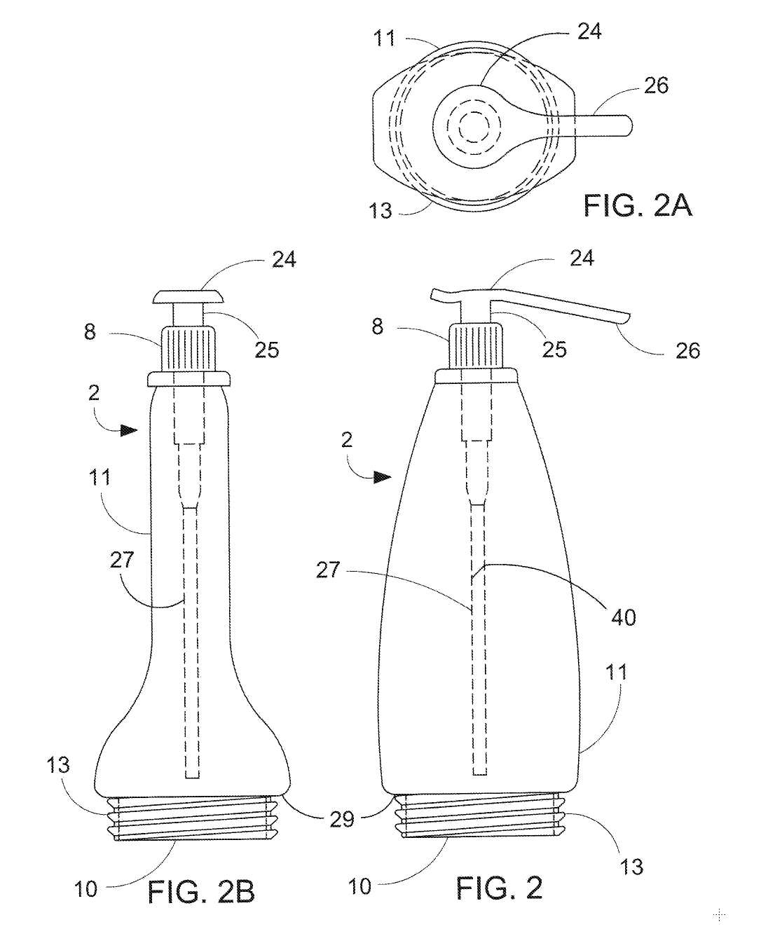

In viewing FIGS. 2, 2A, and 2B, it is observed that a differently shaped container, designated as an elliptical container 2, is constructed very similarly to the previously-shown cylindrical container 4. In FIG. 2B, the side view of the elliptical container 2 reveals that the outer walls 11 of the elliptical container 2 are symmetrically flared to form a circular bottom segment suitable for accommodating outer bottom threads 13. As with the cylindrical container 4, the elliptical container 2 becomes a completely functional container assembly, with the addition of a sealing cup 30 as previously discussed. FIG. 2A depicts a top view of the elliptical container 2, including a pump handle 24 and pump spout 26.

In FIG. 4, a bulb-like container assembly 38 is shown. The bulb-like container assembly 38 is constructed in a very similar manner as the cylindrical container 4 and the elliptical container 2. The bulb-like container assembly 38 also features outer body threads 13 and becomes a fully-functional container assembly with the inclusion of the sealing cup 30 shown in FIG. 3A.

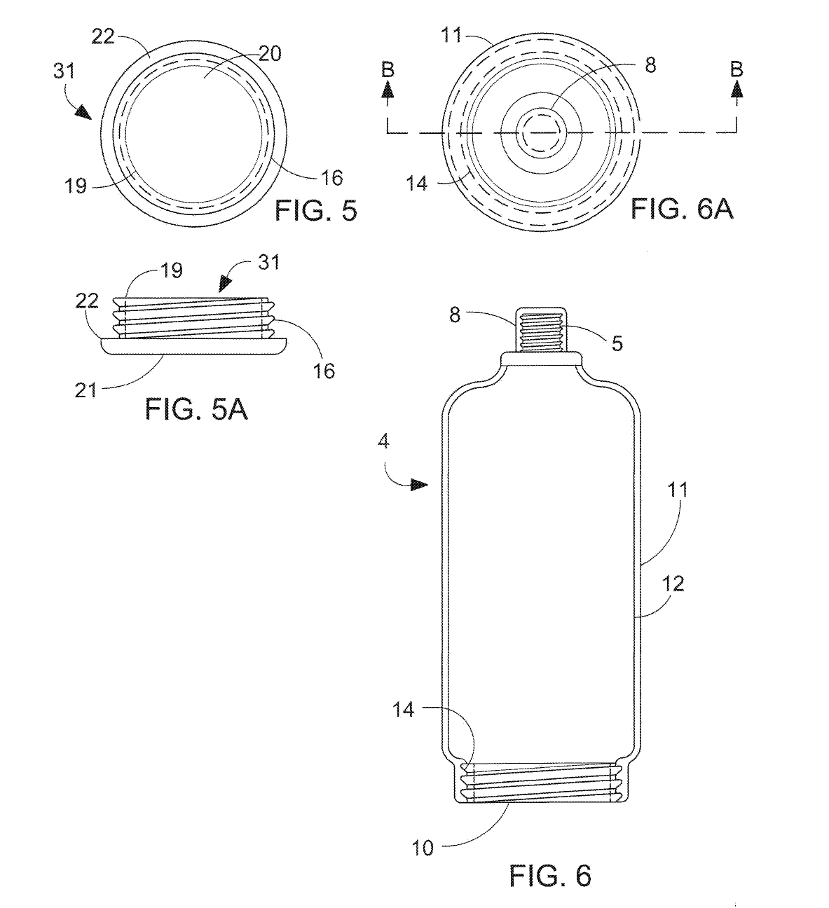

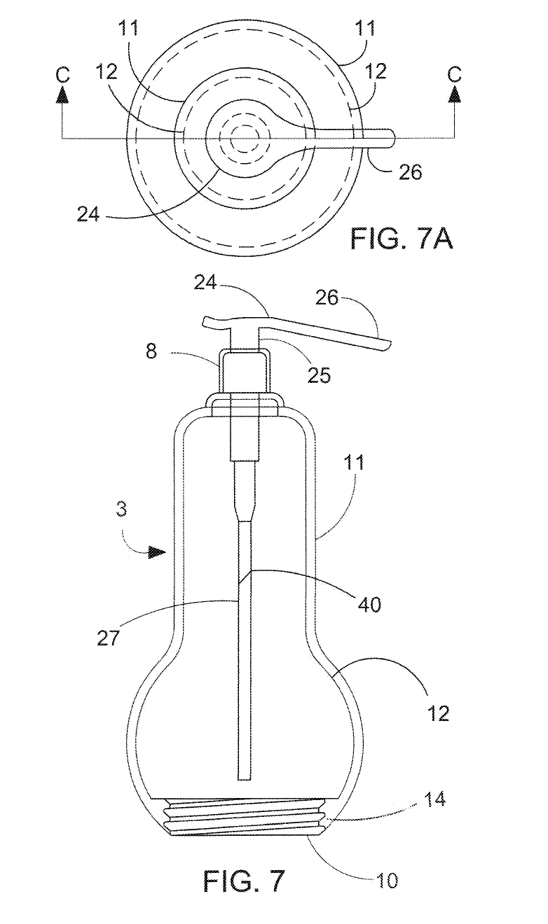

In other embodiments of the inventive concept, FIGS. 6, and 7 illustrate differently configured container assemblies manufactured with inner bottom threads 14. The use of inner bottom threads 14 requires a different type of cup-like structure, preferably a stopper cup 31, as shown in FIGS. 5 and 5A. The stopper cup 31 comprises a circular cup with an inner floor 20, a flat cup bottom 21, and exterior threads 16 which are compatible with the inner bottom threads 14 of the container assemblies shown in FIGS. 6 and 7. Prior to the time of filling of any of the container assemblies with a desired fluid, the stopper cup 31 is rotated, in a clockwise direction, into the inner bottom threads 14 of any one of the containers which may be manufactured with inner bottom threads. As further assurance of preventing leakage of the fluid, a gasket 28 as shown in FIG. 1B, may be abutted against the container bottom rim 10 of any of the containers shown in FIGS. 6 and 7, so as to fit snugly against the lip 22 of the stopper cup 31 as the stopper cup 31 is rotated onto the inner bottom threads 14.

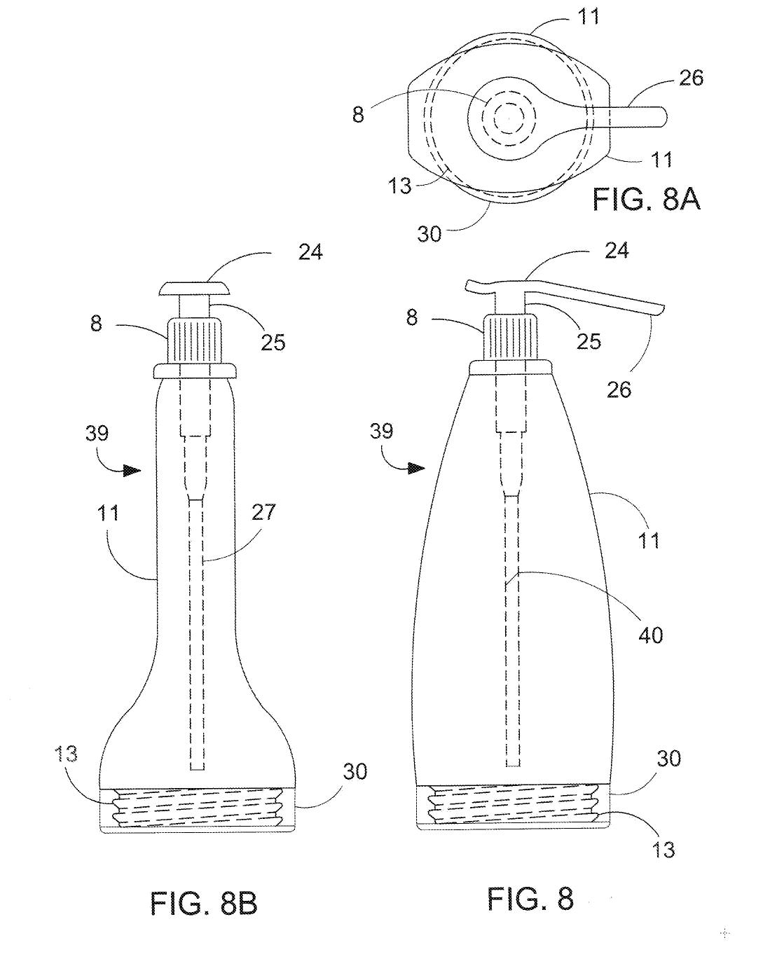

A different embodiment of the inventive concept is presented in FIGS. 8, 8A, and 8B wherein an elliptical container assembly 39 is shown, being constructed with outer bottom threads 13. Also shown is the sealing cup 30 affixed to the bottom opening of the elliptical container assembly.

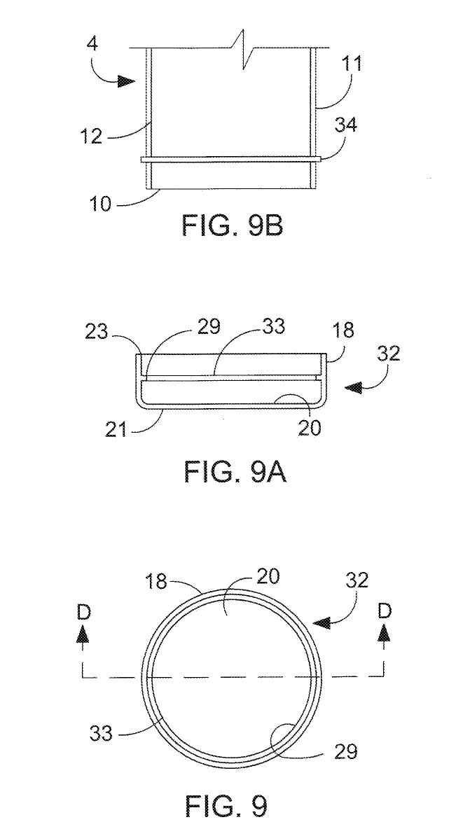

Another embodiment of the inventive concept is presented in FIGS. 9, 9A, and 9B, wherein a generic cylindrical container 4 is constructed having an external perimetral circular flange 34 toward the bottom-most segment of the container 4. A specially-designed cup-like structure, shown in FIGS. 9 and 9A, and designated as a ridged cup 32, provides the means of closing the open bottom of the container 4 for the enclosure of fluids therein.

The ridged cup 32 features an inner floor 20, a cup outer bottom 21, exterior wall 18, and an internal flange 29. Leak-proof sealing of the container assembly is accomplished by superimposing the cup rim 23 of the ridged cup 32 so as to fit congruously with the outer circumference of the container 4. Moderate pressure is directed against the ridged cup 32 so as to force the inner flange 33 upwards over the perimetral circular flange 34 of the container 4. In this manner, the ridged cup 32 is securely fitted onto the open bottom of the container 4.

While preferred embodiments of the present inventive concept have been shown and disclosed herein, it will be obvious to those persons skilled in the art that such embodiments are presented by way of example only and not as a limitation to the scope of the inventive concept. Numerous variations, changes, and substitutions may occur or be suggested to those skilled in the art without departing from the intent, scope, and totality of the inventive concept. Such variations, changes, and substitutions may involve other features which are already known per se and which may be used instead of, or in addition to features already disclosed herein. Accordingly, it is intended that this inventive concept not be limited by the scope of the accompanying claims.

What is claimed is:

1. A container assembly, comprising
a primarily oblong, hollow container having a body, a threaded neck with an opening, and an open bottom portion;
a threaded cap; and
a closing device comprising a cup-like structure having a means of removably attaching said closing device to the open bottom portion of said hollow container.

2. A container assembly, comprising
a primarily oblong hollow container having a body, a threaded neck, and an open circular bottom portion, said bottom portion having bottom outer threads;
a pump spray head having a cap with internal threads compatible with the threads of the neck of said oblong hollow container;
a scored dip tube attached to said spray head; and
a removeable closing device comprising a cup-like structure having interior threads compatible with the bottom outer threads of the bottom portion of said hollow container.

3. A container assembly as in claim 2, further comprising a hollow container having a body with a cylindrical shape.

4. A container assembly as in claim 2, further comprising a hollow container having a body with an elliptical shape and a circular bottom portion.

5. A container assembly as in claim 2, further comprising a hollow container having a body with an elliptical shape and a circular bottom portion.

6. A container assembly as in claim 2, further comprising a hollow container having a body with a bulb-like shape and a circular bottom portion.

7. A container assembly, comprising
a primarily oblong hollow container having a body, a threaded neck, and an open circular bottom portion, said bottom portion having bottom inner threads;
a pump spray head having a cap with internal threads compatible with the threads of the neck of said oblong hollow container;
a scored dip tube attached to said spray head; and
a removeable closing device comprising a cup-like structure having exterior threads compatible with the bottom inner threads of the bottom portion or said hollow container.

8. A container assembly as in claim 7, further comprising a hollow container having a body with a cylindrical shape.

9. A container assembly as in claim 7, further comprising a hollow container having a body with an elliptical shape and a circular bottom portion.

10. A container assembly as in claim 7, further comprising a hollow container having a body with an elliptical shape and a circular bottom portion.

11. A container assembly as in claim 7, further comprising a hollow container having a body with a bulb-like shape and a circular bottom portion.

12. A container assembly, comprising
a primarily oblong hollow container having a body, a threaded neck, and an open bottom portion, said bottom portion having a continuous circular outer flange encompassing its perimeter;
a pump spray head having a cap with internal threads compatible with the threads of the neck of said oblong hollow container;
a scored dip tube attached to said spray head; and
a removeable closing device comprising a cup-like structure having a continuous circular inner flange about its interior perimeter, the inner diameter of said inner flange being slightly less than the outer diameter of said outer flange of the bottom portion of said oblong hollow container.

13. A container assembly as in claim 12, further comprising a hollow container having a body with a cylindrical shape.

14. A container assembly as in claim 12, further comprising a hollow container having a body with an elliptical shape and a circular bottom portion.

15. A container assembly as in claim 12, further comprising a hollow container having a body with an elliptical shape and a circular bottom portion.

16. A container assembly as in claim 12, further comprising a hollow container having a body with a bulb-like shape and a circular bottom portion.
